(19) United States
(12) Patent Application Publication
(10) Pub. No.: US 2006/0151992 A1
(43) Pub. Date: Jul. 13, 2006

(54) Greeting card

(76) Inventor: Greg Balderston, Queensland (AU)

Correspondence Address: Abelman Frayne & Schwab, 150 East 42nd Street, New York, NY, 10017-5612, US

(21) Appl. No.: 10/528,647

(22) PCT Filed: Sep. 22, 2003
(86) PCT No.: PCT/AU03/01247

§ 371 Date: Jul. 20, 2005

(51) Int. Cl. B42D 15/00

(52) U.S. Cl. 283/106

(57) ABSTRACT

This invention relates to a greeting card (10) that includes a candle (11), a first leaf (12), a second leaf (13), and an expandable receptacle (14), located intermediate said first and second leaves, which is adapted to receive the candle.

This invention relates to a greeting card.

This invention has particular, but not exclusive application to a greeting card that houses a candle, and for illustrative purposes reference will be made to said application. However, it will be understood that this invention is not limited to greeting cards for housing candles and that it also applies to greeting cards that may be used to house other articles, including gifts such as a cigar.

Greeting cards are widely know and are often used as a means of expressing one's feelings for another person. With the above in mind, it is possible to purchase greeting cards on which there are printed messages appropriate to a particular occasion, be it a birthday, wedding, or the death of a close friend, by way of example. There are also greeting cards that contain no message at all. These cards lend themselves to a variety of uses which are limited possibly only by the relevance, if any, of any images they may carry.

Most greeting cards are constructed from a single sheet of paper of card board which may be folded, usually along a line of symmetry, so as to create a hinge that connects two opposing leaves, often referred to as the front and back covers respectively, and wherein occasionally there may be provided an insert, generally in the form of a very thin grade of paper, located between said covers.

Some greeting cards include a badge attached thereto. For example, cards that celebrate a child's birthday, may include a badge on which there is printed the child's age, which is attached to an outer face of the front cover. Or an inner face of the back cover, and in the case of the latter, there may be an aperture cut in the front cover through which the badge extends. Other greeting cards may include a small gift attached thereto, such as a baby's comb.

Candles form an integral part of many religious ceremonies. They are often used to symbolise, light, hope and/or life itself. For example, worshippers are encouraged to place lighted candles on church alters in memory of persons dear to them who have passed away.

Persons partaking in religious ceremonies are often given before the commencement of the service a sheet of paper or a small booklet on which their is printed the religious service, including any responses that they will be called upon to make. They may also be given a candle which they will be asked to light during the ceremony.

In order to minimise administrative duties prior to the commencement of religious ceremonies, it may be desirous that worshippers are given selected information regarding the service printed on a card, such as a card comprising a singled leaf or two leaves, possibly with an insert, to which there is attached a candle. It would also appear appropriate that greeting cards given in recognition of a particular event which may be observed by a religious ritual involving the lighting of a candle, might be accompanied by a candle that is attached thereto. To the inventor's knowledge, no such card currently exists.

Candles can be quite fragile, particularly if dropped, and while a wick that extends the length of a candle may prevent the disassociation of adjacent fractured wax components, the relative movement of adjacent parts can be dangerous when the candle is lit. It is therefore felt that the attachment of a candle to an outer face of the front cover of a greeting card would not adequately protect the candle from damage. Nor would the attachment of the candle to the outer face of the front cover necessarily aid in the stacking of like cards either one on top of the other for packaging purposes, or one behind he other, for display purposes.

Depending upon the method used to attach the candle to the outer face of the front cover, the candle may be easily separated from the card during handling and wherein this may lead to the possible loss and/or damage of the candle while displayed in retail outlets. In addition, separation of the candle from the card may damage any artwork displayed on the front cover thereby reducing the card's appeal for sentimental and/or aesthetic reasons.

It is also common when giving gifts to include a greeting card. Often the gift is wrapped in pretty paper and the card is attached to the paper using a suitable adhesive tape. Finding a suitable card and wrapping paper that match can sometimes be a problem. Similarly, wrapping the gift takes time, and to some, may seem a wasted effort, as the wrapping paper is often quickly discarded and forgotten by the recipient of the gift. It would appear that a greeting card which may also be used to wrap a small gift would be advantageous.

It is an object of the present invention to provide a greeting card that obviates at least some of the disadvantages of the prior art and which will be reliable and efficient in use.

Other objects and advantages will hereinafter become apparent.

With the forgoing in view, this invention in one aspect relates to a greeting card that is capable of retaining an article there within and which, together with said article, is intended to be given by the owner of same to someone else as a unitary item, said article being later separable from said greeting card, said greeting card including:

a first leaf;

a second leaf, and

an expandable receptacle having a mouth through which the article to be retained may pass and a cavity located behind said mouth that is adapted to receive the article, said receptacle being located intermediate and connected to both said first leaf and said second leaf, whereby said first leaf is capable of hinge like movement relative to said second leaf between a closed position, wherein the two leaves overly one another in a manner that at least partially closes said mouth, and an open position, wherein the two leaves are splayed apart thereby opening said mouth and enabling the article to pass through said mouth if so desired. To assist with the retention of the article by the receptacle, a suitable adhesive and/or a strip of a suitable adhesive tape may be used to releasably attach the article to a wall of the receptacle.

The two leaves and the receptacle are preferably of unitary construction. For example, the two leaves and the receptacle may be constructed from a single piece of paper, cardboard or a suitable plastics materials. However, it will also be appreciated that the two leaves and the receptacle may be constructed separately and from different materials if so desired.

The receptacle may include two opposing jaws that are hingedly connected together along a common edge, seam, web or join. Each jaw may include one or more wall portions that when combined define a cavity that is adapted to receive an article and wherein opposing wall portions of the two jaws either abut or are separated by a small gap or mouth, remote from the web.

Whether the article conforms to the shape of the cavity depends upon the external shape of the article, which need not necessarily have a generally circular transverse cross-section, and the internal profile of the two jaws. For example, each jaw may include two or more angled faces which may resemble and function like teeth that in turn may engage the article.

The hinge like connection joining the two jaws may resemble a spring which may be adapted to urge the aforementioned opposing wall portions together and wherein, in some embodiments, this spring like force may enable the jaws to grip the article that is located there between, possibly obviating the need for adhesives and/or adhesive tape to hold the article in place.

In a preferred embodiment, the receptacle comprises a thin walled piece of moulded cardboard having a generally “C” shaped transverse cross-section. The stiff cardboard is permitted to flex generally along an axis of symmetry that is located approximately midway between two arcuate jaws.

The two leaves may take any suitable shape, including a variety of both regular and irregular shapes. For example, the leaves may be generally square or rectangular. Alternatively, the shape of the leaves may resemble the silhouette of a common object, building, animal, human being or part thereof.

Each leaf is preferably connected to a wall portion of a respective jaw. In one embodiment, the connection may be a flexible connection. This may be produced in a variety of ways, such as by lightly scoring or folding the material so as to create a fold line. However, it is preferred that the connection is a rigid connection.

The article may include generally cylindrically shaped objects, such as candles, cigars, pencils, as well as various sexual aids and massage tools. Alternatively the article may include a generally cylindrically shaped container that may be used to house any number and variety of objects that themselves may be difficult or impossible to be satisfactorily retained by the receptacle.

In another aspect, this invention relates to a greeting card including:

a candle;

a first leaf;

a second leaf, and

an expandable receptacle having a mouth through which said candle may pass and a cavity located behind said mouth that is adapted to receive said candle, said receptacle being located intermediate and connected to both said first leaf and said second leaf, whereby said first leaf is capable of hinge like movement relative to said second leaf between a closed position, wherein the two leaves overly one another in a manner that at least partially closes said mouth, and an open position, wherein the two leaves are splayed apart thereby opening said mouth and enabling said candle to pass through said mouth if so desired.

In another aspect, this invention relates to a greeting card that is capable of retaining an article there within and which, together with said article, is intended to be given by the owner of same to someone else as a unitary item, said article being later separable from said greeting card, said greeting card including:

a first leaf;

a second leaf, and

a receptacle located intermediate and connected to both said first leaf and said second leaf whereby said first leaf is capable of hinge like movement relative to said second leaf.

In order that this invention may be more easily understood and put into practical application, reference will now be made to the following drawings:

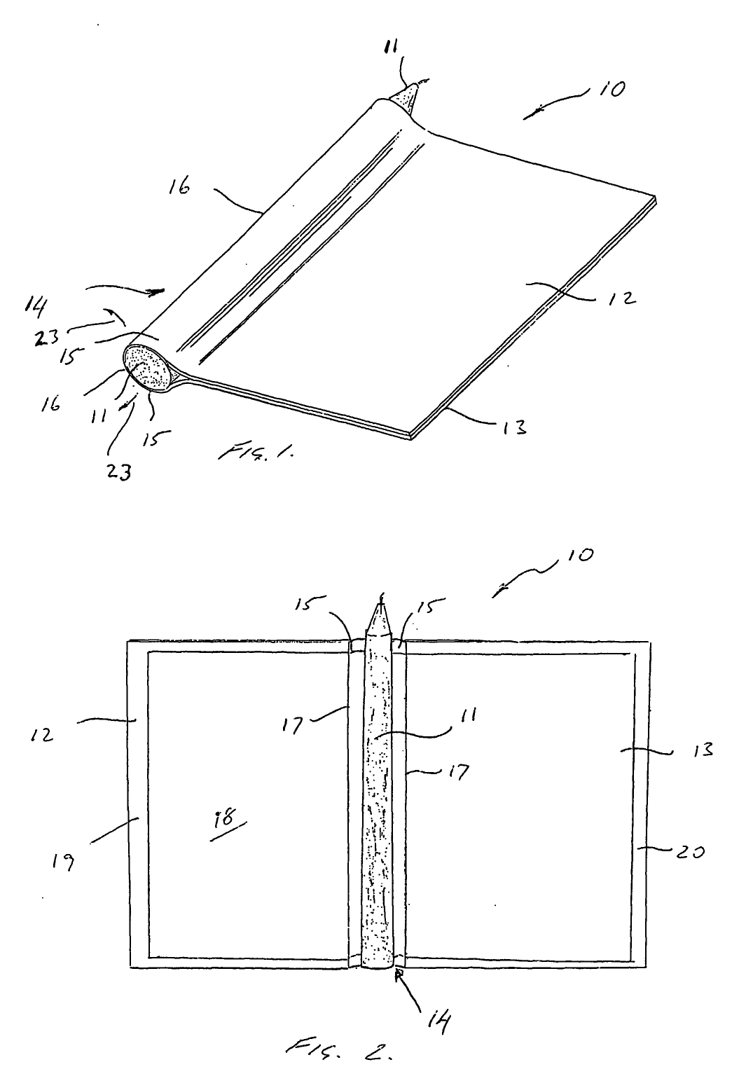

FIG. 1 shows a pictorial view of a greeting card constructed in accordance with the present invention, and

FIG. 2 shows another pictorial view of the greeting card shown in FIG. 1.

FIGS. 1 and 2 show a greeting card 10, constructed from a sheet of paper card, that is adapted to hold a candle 11.

The card 10 includes a first leaf or front cover 12, and

a second leaf or back cover 13.

The two leaves 12 and 13 are substantially rectangular in shape and are interconnected by an intermediate receptacle 14.

The receptacle 14 has a generally “C” shaped transverse cross-section and comprises two opposing stiff, arcuate, jaws 15 that are interconnected by a flexible web like portion 16 that functions like a spring urging opposing arcuate wall portions 17 of the two jaws togther.

The two leaves 12 and 13 are each rigidly connected to a respective wall portion 17, as shown.

The greeting card 10 also includes an insert 18 comprising a thin sheet of paper that has been affixed to the internal faces 19 and 20 of the leaves 12 and 13 respectively. A message or greeting 22 may be written on the insert.

In use, the splaying apart of the two leaves 12 and 13, as shown in FIG. 2, will cause the web 16 to flex in the direction of arrows 23 thereby opening the mouth, defined by the gap separating opposing wall portions 17, wide enough to allow an article, such as a candle 11, to pass there through. When the external force holding the splayed leaves 12 and 13 apart is removed, the spring like web 16 urges the two leaves 12 and 13 together, as shown in FIG. 1, and the two opposing jaws 15 close about the candle.

Rather than rely solely on the jaws 15 to hold the candle 11 in place, a small dab of a suitable non-permanent adhesive, not shown, is used to affix the candle to the web 16.

It will be appreciated that the card 10 and the candle 11 may be given as a gift, and whereas the candle may be used as part of a religious ceremony, the card and the message written inside on the insert may be retained as a keepsake if so desired.

It will also be appreciated that the cardboard that surrounds the candle offers protection for the candle against damage either while in transit or when on display and prevents the candle from being accidentally separated from the card.

It will also be appreciated that the above example is given as an illustration only of the present invention and that all such modifications and variations thereto as would be apparent to persons skilled in the art are deemed to fall within the broad scope and ambit of this invention as herein defined in the appended claims.

1-16. (canceled)

17. A greeting card that is capable of retaining an article there within and which, together with said article, is intended to be given by the owner of same to someone else as a unitary item, said article being later separable from said greeting card, said greeting card including:
a first leaf;
a second leaf, and
an expandable receptacle having a mouth through which the article to be retained may pass a cavity located behind said mouth that is adapted to receive the article, said receptacle being located intermediate and connected to both said first leaf and said second leaf, whereby said first leaf is capable of hinge like movement relative to said second leaf between a closed position, wherein the tow leaves overlie one another in a manner that at least partially closes said mouth, and an open position, wherein the two leaves are splayed apart thereby opening said mouth and enabling the article to pass through said mouth if so desired.

18. A greeting card as claimed in claim 17, wherein said two leaves and said receptacle are of unitary construction.

19. A greeting card as claimed in claim 18, wherein said two leaves and said receptacle are constructed from a single piece of cardboard.

20. A greeting card as claimed in claim 17, wherein said receptacle includes two opposing jaws that are hingedly connected together by a common web and wherein each jaw includes one or more wall portions that when combined define a cavity that is adapted to receive the article.

21. A greeting card as claimed in claim 18, wherein said receptacle includes two opposing jaws that are hingedly connected together by a common web and wherein each jaw includes one or more wall portions that when combined define a cavity that is adapted to receive the article.

22. A greeting card as claimed in claim 19, wherein said receptacle includes two opposing jaws that are hingedly connected together by a common web and wherein each jaw includes one or more wall portions that when combined define a cavity that is adapted to receive the article.

23. A greeting card as claimed in claim 20, wherein said mouth is defined by the gap separating opposing wall portions of said respective two jaws remote from said web.

24. A greeting card as claimed in claim 20, wherein said web resembles a spring and is adapted to urge the aforementioned opposing wall portions of said receptacle together such that they close about the article.

25. A greeting card as claimed in claim 21, wherein said web resembles a spring and is adapted to urge the aforementioned opposing wall portions of said receptacle together such that they close about the article.

26. A greeting card as claimed in claim 22, wherein said receptacle comprises a thin walled piece of moulded cardboard having a generally “C” shaped transverse cross-section which is permitted to flex generally along an axis of symmetry.

27. A greeting card as claimed in claim 23, wherein the article is a candle.

28. A greeting card including:
a candle;
a first leaf;
a second leaf, and
an expandable receptacle having a mouth through which said candle may pass and a cavity located behind said mouth that is adapted to receive said candle, said receptacle being located intermediate and connected to both said first leaf and said second leaf, whereby said first leaf is capable of hinge like movement relative to said second leaf between a closed position, wherein the two leaves overlie one another in a manner that at least partially closes said mouth, and an open position, wherein the two leaves are splayed apart thereby opening said mouth and enabling said candle to pass through said mouth if so desired.

29. A greeting card as claimed in claim 25, wherein said two leaves and said receptacle are of unitary construction.

30. A greeting card as claimed in claim 26, wherein said two leaves and said receptacle are constructed from a single piece of cardboard.

31. A greeting card as claimed in claim 27 wherein said receptacle includes two opposing jaws that are hingedly connected together by a common web and wherein each jaw includes one ore more wall portions that when combined define a cavity that is adapted to receive said candle.

32. A greeting card as claimed in claim 28, wherein said mouth is defined by the gap separating opposing wall portions of said respective two jaws remote from said web.

33. A greeting card as claimed in claim 29, wherein said web resembles a spring and is adapted to urge the aforementioned opposing wall portions of said receptacle together such that they close about said candle.

34. A greeting card as claimed in claim 30, wherein said receptacle comprises a thin walled piece of moulded cardboard having a generally “C” shaped transverse cross-section which is permitted to flex generally along an axis of symmetry.
